(19) United States
(12) Patent Application Publication
(10) Pub. No.: US 2007/0140820 A1
(43) Pub. Date: Jun. 21, 2007

(54) Tarp lift/person lift for a flatbed trailer

(75) Inventor: Jeff Miller, Scott City, MO (US)

Correspondence Address: THOMPSON COBURN, LLP, ONE US BANK PLAZA, SUITE 3500, ST LOUIS, MO, 63101, US

(73) Assignee: JAMCO Transportation LLC

(21) Appl. No.: 11/312,226

(22) Filed: Dec. 20, 2005

(51) Int. Cl. B60P 1/00

(52) U.S. Cl. 414/540

(57) ABSTRACT

Lifts for cargo carrying vehicles (e.g. trucks) and methods of lifting objects associated with such vehicles. The lift may include a deployment mechanism, a lift mechanism, and a lift deck. The deployment mechanism couples to the frame of the vehicle and deploys the lift mechanism to a position adjacent to the vehicle where the lift mechanism lifts the lift deck to a position that is substantially above the a cargo support surface of the vehicle. Preferably, the lift mechanism includes a pneumatic actuator sized to extend the lift mechanism about 84.″ A housing may also be provided on the vehicle for the lift. In one embodiment, the deployment mechanism is a slide mechanism and the lift mechanism is a scissor mechanism. A support bracket may be included to support the deployed lift mechanism. Additionally, a handrail may be provided on the lift deck.

### FIELD OF THE INVENTION

This invention relates generally to methods and apparatus for protecting cargos on vehicles and, more particularly, to methods and apparatus for covering loads on flatbed trailers with protective tarps.

### BACKGROUND OF THE INVENTION

In the transportation industry the loads carried by vehicles such as tractor-trailers are typically maximized to improve the efficiency with which the loads are shipped. For this reason, among others, the cargo to be carried on flatbed trailers is stacked to substantially fill the cargo carrying volume of the trailer. More particularly, lumber is typically shipped in long pieces that can occupy the entire length (about 48 feet) of the trailer. The lumber is usually lifted by way of an overhead crane onto the cargo support surface of the trailer. The boards are also typically stacked side-by-side and one on top of the other until the width of the support surface is covered to a depth of 60 inches or so.

For many types of cargo it is desired by the cargo manufacturers, the truck operators, the retailers, and ultimately the consumers to have the cargo covered while in transit. Further, when the cargo is a high value product such as hardwood flooring planks, those involved in its distribution desire the product to be protected from wind, precipitation, sunlight exposure, and other potential sources of damage or degradation. Accordingly, the vehicle operator is called upon to cover the product with tarps or other protective covers after the cargo is loaded.

However, the sheer bulk of certain types of cargo create difficulties for the operator in protecting the cargo. First, the cargo support surface of the trailer can be about 4 feet from the ground. The cargo stacked on the trailer surface can reach another 60 inches or more above the deck. Therefore the top of the cargo, which is the area of the cargo that is most exposed to the elements, is about 9 feet or more from the ground. Clearly, under these circumstances, even very tall operators have difficulties in reaching and covering the top of the cargo.

As a result, operators may be tempted to climb on the vehicle or the cargo to reach the top of the cargo. Typically operators will either heave the tarps onto the cargo from below while on the ground (thereby pre-positioning the tarps on top of the cargo) or they will attempt to climb the cargo with the tarps in hand. Either approach presents difficulties of its own. For one thing, while working alongside the vehicle the operator is exposed to the risks associated with passing traffic. Additionally, even if the tarps are pre-positioned in a manner such that they are distributed evenly along the cargo, the tarps can roll off of the cargo thereby causing the operator to have to return to the ground to once again pre-position the tarp. Further, while the operator is climbing on the trailer and cargo mishaps can occur. Moreover, once the operator completes covering the cargo the operator needs a new way to reach the ground because many of the hand and foot holds that enabled the operator to climb the cargo may be covered by the tarps.

Therefore, a need exists for better methods of getting from ground level to cargo height, then returning safely back to ground, without ever lifting the tarps.

### SUMMARY OF THE INVENTION

It is a result of the above problems that the present invention was developed. The invention provides apparatus for, and methods of, lifting tarps and drivers to cargo level safely while tarping loads on a flatbed trailer.

In a first preferred embodiment, the present invention provides a lift for a vehicle, for example a trailer. The lift includes a deployment mechanism a lift mechanism, and a lift deck. The deployment mechanism couples to the frame of the trailer beneath a cargo support surface of the trailer and deploys the lift mechanism to a position adjacent to one side of the trailer. In the deployed position the lift mechanism lifts the lift deck to a position that is substantially above the support surface of the trailer. Preferably, the lift mechanism includes a pneumatic actuator that is sized to extend the lift mechanism by about 84 inches using compressed air from the pneumatic system of the tractor that tows the trailer. A housing may also be provided on the trailer for the lift mechanism. In one embodiment, the deployment mechanism is a slide mechanism and the lift mechanism is a scissors jack mechanism. A support bracket may also be included to support the deployed lift mechanism. Additionally, a hand rail may be provided on the lift deck. Other embodiments of the present invention include a platform on the lift deck that can be moved to a ramped position so that objects on the platform can roll down the platform toward the vehicle.

In a second preferred embodiment, a vehicle is provided that includes a frame, a cargo support surface, a deployment mechanism, a lift mechanism, and a lift deck. The cargo support surface and the deployment mechanism are both coupled to the frame of the vehicle. Further, the deployment mechanism can be configured to deploy the lift mechanism to a position adjacent to the one side of the trailer. Preferably, the vehicle further comprises a pneumatic system in fluid communication with the lift mechanism to move the lift mechanism between an extended, raised position and a contracted, lowered position. The trailer will also include a housing for the lift mechanism.

In another embodiment, the vehicle is a flatbed tractor-trailer truck with the housing being under the frame of the cargo support surface of the flatbed trailer.

Additionally, the invention provides methods of operating vehicles. In one preferred method, a lift mechanism is moved from a stowed position (in which the lift mechanism may be housed) on a vehicle to a deployed position that is adjacent to the trailer. Preferably, the deployed position is adjacent to the one side of the trailer. In the current method, the lift mechanism is also moved between a contracted position (that is at substantially the same elevation as the stowed position of the lift mechanism) and an extended position wherein a lift deck of the lift is raised to at least the elevation of the cargo support surface of the vehicle. Additionally, tarps may be placed on the lift deck and raised with the lift deck and then placed on cargo that is on the trailer support surface. Further, an operator may ride the lift deck to a desired height and then place the tarps onto the cargo. To move the lift mechanism between the contracted position and the extended position, air from the pneumatic system of the vehicle may be used.

Further features and advantages of the present invention, as well as the structure and operation of various embodiments of the present invention, are described in detail below with reference to the accompanying drawings.

### BRIEF DESCRIPTION OF THE DRAWINGS

The accompanying drawings, which are incorporated in and form a part of the specification, illustrate exemplary embodiments of the present invention and together with the description, serve to explain the principles of the invention. In the drawings:

FIG. 1 illustrates a side elevation view of a flatbed trailer that is constructed in accordance with the principles of the present invention;

FIG. 2 illustrates a rear elevation view of the flatbed trailer of FIG. 1;

FIG. 3 illustrates a side elevation view of the trailer of FIG. 1 with the lift in a stowed position;

FIG. 4 illustrates a perspective view of a housing for the lift mechanism of FIG. 1; and

FIG. 5 illustrates a cross sectional view of a deployment mechanism of the lift of FIG. 1; and

FIG. 6 illustrates a deployment mechanism of another preferred embodiment of the lift of FIG. 1.

### DETAILED DESCRIPTION OF THE PREFERRED EMBODIMENTS

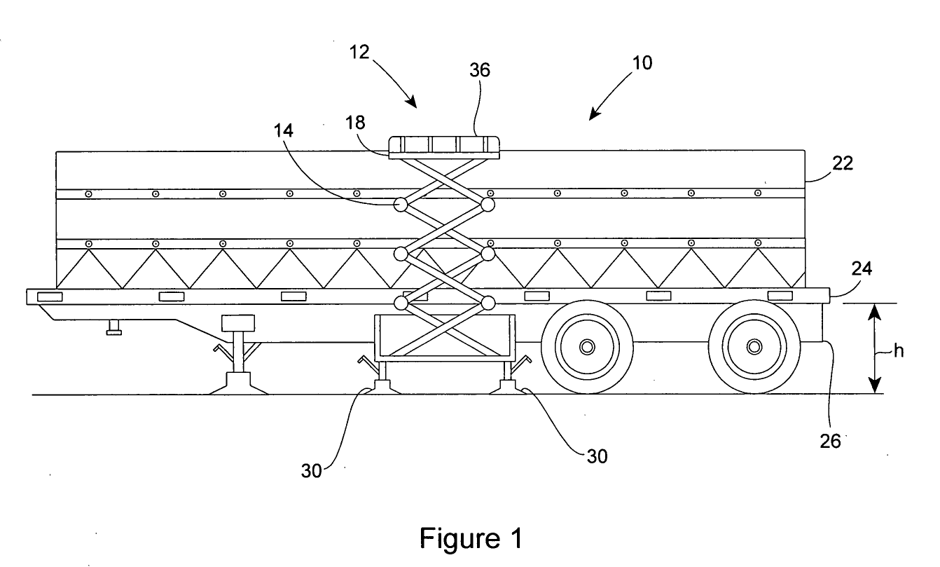

Referring to the accompanying drawings in which like reference numbers indicate like elements, FIG. 1 illustrates a flatbed trailer that is constructed in accordance with the principles of the present invention.

The flatbed trailer 10 of the present embodiment includes a lift 12 that further includes a lift mechanism 14 and a lift deck 18. As is known, the trailer has a length direction that is generally parallel to the direction the trailer travels, and a width direction that is generally perpendicular to the length. A tarp 36 is in FIG. 1 shown positioned on the lift deck 18 above a cargo or load 22 on the trailer 10. More particularly, the cargo 22 rests on and is typically secured to a cargo deck, or support surface 24, of the trailer 10. Further, a frame 26 of the trailer 10 is shown that supports the cargo support surface 24.

Preferably, the lift mechanism 14 is mounted on an aluminum plate in the bottom of the housing 16. In turn, the aluminum plate is mounted on a pair of rails 28 which slide outwardly from the housing beneath the frame 26 of the trailer 10. The lift mechanism is located (when deployed) adjacent to the one side of the trailer 10, preferably the passenger side. The lift mechanism 14 has a contracted position in which it is in a compact configuration suitable for storage and in which it is preferably underneath the cargo support surface 24. In its extended position (shown in FIG. 1) the lift mechanism 14 supports the lift deck 18 generally at or above the top surface of the cargo 22. Of course, the lift mechanism 14 is capable of moving the lift deck 18 between the position shown in FIG. 1 and the contracted position in which it is generally below the height “h” of the support surface 24 (typically about 37″). In the current embodiment the lift mechanism 14 includes a scissor jack mechanism which is preferred in part because of its sturdy construction, ability to lift objects through a great distance, and compact storage configuration when in the contracted position. Additionally, one or more landing gear or braces 30 (that preferably pivot and fold up to positions beside the rails 28 for storage) can be provided to support the lift 12 when in the deployed position. Many types of equivalents to the lifting mechanism 14 are available that could be used in lieu of the scissor jack that is illustrated. For instance, various pneumatic lifts, hydraulic lifts, other kinematic mechanisms (e.g. parallelogram lifts), hoists, derricks, and cranes can be used instead of the scissor jack lift mechanism 14.

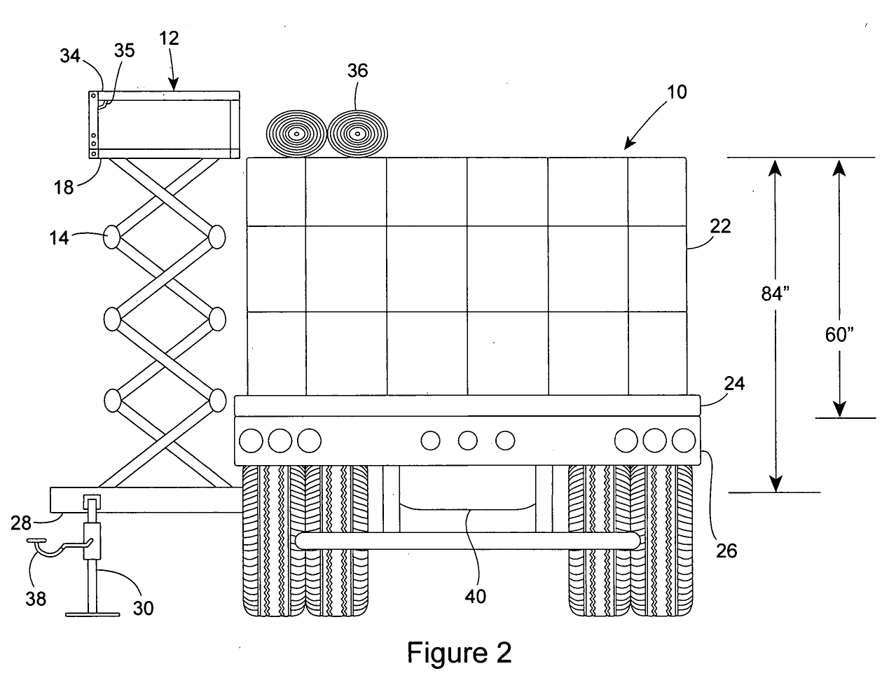

With reference now to FIG. 2, a rear elevation view of the trailer 10 and lift 12 are shown. Again, the lift 12 is shown to the left, or driver's side, but may be mounted on the passenger side of the trailer 10 and in an extended position wherein the lift deck 18 is at or above the highest point of the cargo 22. Additionally, support brackets (or landing gear) 30, a hand rail 34, several tarps 36, a hand crank 38 for operating the braces 30, and an air tank 40 of the trailer 10 are shown. As illustrated in FIG. 2, the lift mechanism 14 couples to and is supported by the rails 28. In turn, the rails 28 are coupled to the frame 26 and slides outwardly from a stowed position generally underneath the cargo support surface 24 to the deployed position of the rails 28 and the lift 12 shown in FIG. 2. The landing gear 30 is coupled to the bottom of the rails 28 and can be moved to the deployed positions shown in FIG. 2 to provide further support to the lift mechanism 14 via the rails 28.

While the lift mechanism 14 may be moved using pressurized air from the pneumatic system of the trailer 10 (here represented schematically via the air tank 40) a hand crank or other actuator may be operatively connected to the lift mechanism 14 to move the lift mechanism 14 between the contracted position and the extended position. No matter which source of energy is used to move the lift mechanism 14, loads can be lifted from near the ground to above the cargo 22 using the lift 12. In particular, the invention allows the tarps 36 to be lifted to near the top of the cargo 22. Once near the top of the cargo 22, the operator of the truck may roll the tarps 36 onto the cargo 22 and distribute the tarps 36 along the length of the cargo 22. Thus, the operator may easily and conveniently spread the tarps 36 across the cargo 22 to protect the cargo from the elements without having to climb on the trailer 10 or the cargo 22. Of course, the operator may also use the lift 12 to lower rolled up tarps 36 to the ground after gathering them from the cargo 22.

The advantages of using the lift 12 to (un)cover the cargo 22 with the tarps 36 are numerous. They include eliminating the desire for the operator to climb on, and potentially damage, the cargo 22. Further, the operator will not need to carry the tarps 36 while climbing to the top of the cargo 22. Nor does the operator need to pre-position the tarps 36 on top of the cargo 36. Furthermore, because the lift 12 allows the operator to ride up and down, the desire of the operator to climb on, or jump from, the cargo 22 is likewise eliminated. To facilitate the riding of the lift 12, the handrail 34 may therefore be provided. While the handrail 34 could be mechanically linked to the lift mechanism 14 (so that it moves into position when the lift mechanism 14 expands), the handrail 34 is preferably snapped into place by the operator and otherwise is preferably stored on the side of the housing 16. After attachment, the handrail 34 maybe locked in the upright position by way of a locking linkage 35 or other suitable mechanism. Of course, the handrail 34 may be open on the side of the lift deck 18 that is adjacent to the cargo 22. Also, the operator may use a safety harness attaching it to the lift deck or other suitable structure. For this purpose a hole or some other suitable means of attaching the safety harness may be provided in the lift deck 18.

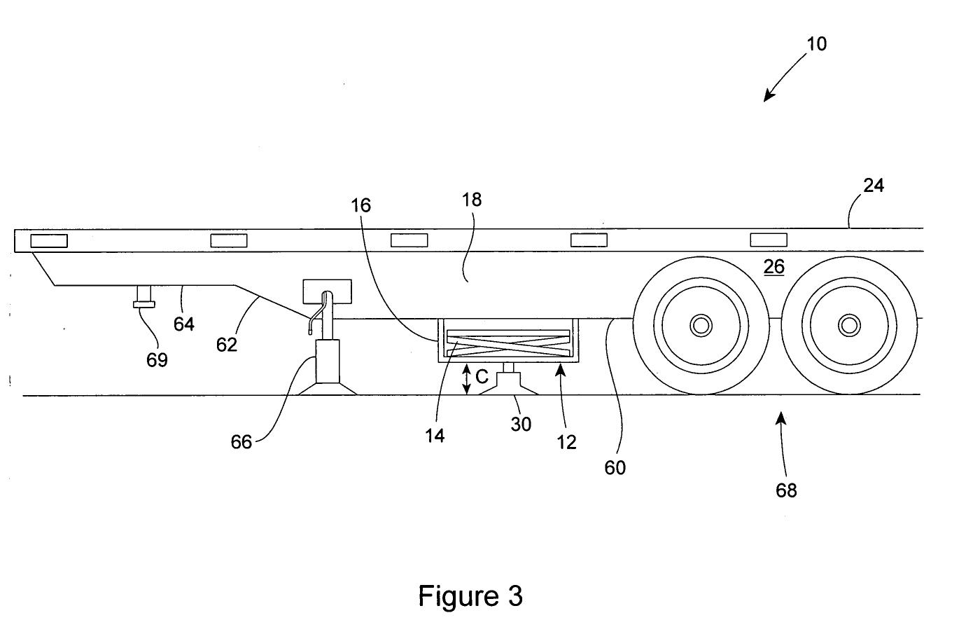

Turning now to FIG. 3, the lift 12 of FIGS. 1 and 2 is shown in its stowed position underneath the trailer 10 and within the housing 16. In the stowed position the lift mechanism 14 is typically in its fully contracted position although some extension of the lift mechanism 14 is permitted. Moreover, when in the stowed position, the lift mechanism 14 has been slid along the rails 28 into the housing 16. FIG. 3 also illustrates that the housing 16 is sized to accommodate the length, width, and height of the contracted lift mechanism 14 with the lift deck 18 coupled thereto. Furthermore, FIG. 3 shows that the housing 16 is coupled to the lower side of the trailer frame 26 and preferably at a location where a clearance “c” is provided between the bottom of the housing 16 and the ground. In this manner, the trailer 10 can traverse uneven terrain or pavement without causing the housing 16 to strike the same.

FIG. 3 also shows a preferred location for the housing 16 relative to various structures of the trailer 10. More particularly, several sections 60, 62, and 64, of the frame 26 and a landing gear 66, running gear 68, and king pin 69 of the trailer 10 are shown. Preferably, the housing 16 (and lift 12) are positioned between the king pin 69 and running gear 68. Even though the lift 12 could be positioned anywhere along the length of the frame 26, it is preferred that the lift 12 be housed at a position along one of the constant width portions 60 or 64 of the frame 26. Of course, the housing 16 (or lift 12) could be mounted to the transition portion 62 of the frame if the mounting arrangement accommodates the sloped profile of the transition portion 62. In FIG. 3, therefore, the housing 16 is shown as being coupled to, and beneath, the wider portion 60 of the frame 26 although it could be coupled to the thinner portion 64 particularly if more clearance “c” with the ground is desired. Likewise, the housing could be located just below the cargo support surface 24 (i.e. at the side of the frame) if it is desired to maximize the clearance “c.” In such cases it may be desirable to modify or otherwise accommodate the cross members (not shown) of the frame 26. In any case, it is preferred that the housing 46 be located at a position such that access to the landing gear 66, running gear 68, and king pin 69 will be unaffected by the presence of the housing 16. Moreover, while FIG. 3 shows the lift 12 being position for deployment adjacent to the driver side of the trailer 10, the lift 12 could be positioned to be deployed from the opposite side, the rear, or the front of the trailer 10 without departing from the concept of the present invention.

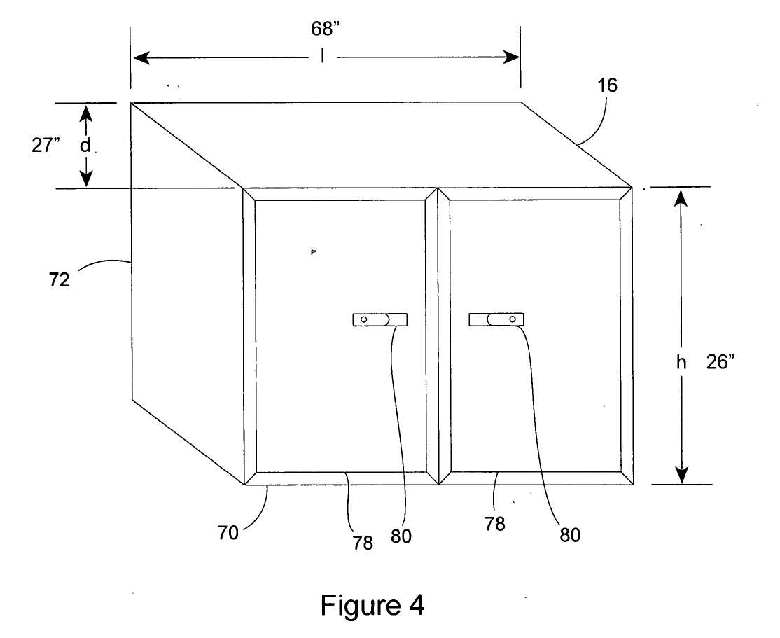

With reference now to FIG. 4, a preferred embodiment of the housing 16 is illustrated. More particularly, FIG. 4 shows that the housing 16 can include a pair of doors 78 with handles 80 for operating the doors 78. Thus, with the doors 78 closed the housing 16 shields the lift from exposure to the elements and particularly road debris and precipitation. Otherwise, when the doors 78 are open, the doors 78 allow the lift 12 to move between the stowed and deployed positions. In one preferred embodiment, the housing 16 is about 26″ in height “h” by 68″ in length “l” by 27″ in depth “d.” Furthermore, the housing 16 may generally be constructed from aluminum to minimize the weight of the trailer 10 while providing sufficient strength to couple the lift 12 to the trailer 10 and to support the lift 12 in use and when stored. It has been found that a housing 16 similar to the housing shown in FIG. 4 is sufficient to house (a Model No. 36S25 EXN SP pneumatic lift which is offered by the Autoquip Corporation of Guthrie, Okla.). Moreover, the preferred Model No. 36S25 EXN SP surface mounted lift can operate using the 120 psia air nominal available from the pneumatic system of typical trailers 10.

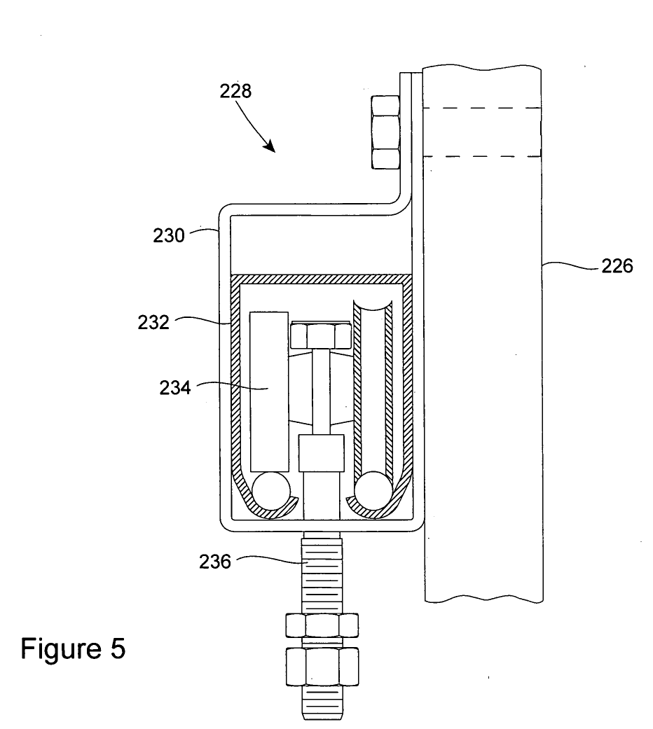

Referring now to FIG. 5, a deployment mechanism 228 can include one or more Model No. 25 tracks (available from Crown Industrial of South San Francisco, Calif.). The deployment mechanism 228 may also include a sidewall bracket 230, a track 234, and an attachment point (e.g. a bolt) 236. The sidewall bracket 230 mounts to a cross member 226 of the frame of the trailer (or to the inside of the housing 16). Together, the bracket 230 and the cross member 226 contain the Model No. 25 track 232. Within the track 232, rollers 234 carry the attachment bolt 236 and allow the same to translate relative to the frame 26 of the trailer. Of course, the lift 12 attaches to the attachment bolt 236 and translates with the bolt 236 as it is deployed or moved into the stowed position. Note that FIG. 5 is adapted from information found at the Crown Industrial website (http://www.crown-industrial.com/). Generally, the slide rail assembly 328 corresponds to the rails 28 of FIG. 2 and carry the lift mechanism 14 between the stowed and deployed positions. Even though FIG. 5 shows a slide rail being used as the deployment mechanism any suitable mechanism could be employed to move the lift mechanism between the stowed and deployed positions. For instance a swing arm pivotably connected to the frame could be used to move the lift mechanism. In the alternative, pneumatic, hydraulic, or even electrical actuators could be used to deploy and stow the lift mechanism.

In view of the foregoing, it will be seen that the several advantages of the invention are achieved and attained. More particularly, apparatus for covering the cargo on vehicles have been provided along with methods for doing the same. Accordingly, less operator time is required for (un)covering loads on vehicles such as flatbed tractor-trailers. Moreover, the present invention enhances the safety of the vehicle operator by eliminating the need for the operator to climb on, or jump down from, the cargo. Thus, the vehicles equipped and operated in accordance with the principles of the present invention should require less down time associated with covering the cargo and correspondingly increased revenues.

As various modifications could be made in the constructions and methods herein described and illustrated without departing from the scope of the invention, it is intended that all matter contained in the foregoing description or shown in the accompanying drawings shall be interpreted as illustrative rather than limiting. For example, rather than being mounted on a truck or trailer thereof), lifts constructed in accordance with the present invention may be mounted on other vehicles such as train cars (particularly flatbed train cars), sport-utility vehicles, vans, buses,cube trucks, aircraft, and ships. Thus, the breadth and scope of the present invention should not be limited by any of the exemplary embodiments, but should be defined in accordance with the claims and their equivalents.

What is claimed is:

1. A lift for use with a vehicle, the vehicle having a frame and a cargo support surface coupled to the frame, the lift comprising:
a deployment mechanism coupled to the frame, the deployment mechanism being movable between a stowed position within the frame and a deployed position at one side of the frame;
a lift mechanism coupled to the deployment mechanism, the lift mechanism being movable vertically when the deployment mechanism has been moved from the stowed position to the deployed position, the lift mechanism being movable vertically between an extended position and a contracted position relative to the vehicle; and
a lift deck coupled to the lift mechanism whereby the lift mechanism in the extended positions the lift deck above the height of the cargo support surface.

2. The lift of claim 1 further comprising: a pneumatic actuator operatively connected to the lift mechanism for moving the lift mechanism between the extended position and the contracted position.

3. The lift of claim 1 further comprising: a housing on the frame, the lift mechanism to be contained in the housing when the lift mechanism is in the contracted position and the deployment mechanism is in the stowed position.

4. The lift of claim 1 further comprising: the deployment mechanism having at least one rail that is extendable from a side of the frame.

5. The lift of claim 1 further comprising: the lift mechanism having a scissor mechanism that moves the lift deck between the extended position and the contracted position.

6. The lift mechanism of claim 1 further comprising: a support bracket including a distal end and a proximal end, the proximal end being coupled to the deployment mechanism and the distal end being adapted to rest on the ground, whereby the support bracket supports the deployment mechanism when the deployment mechanism is in the deployed position.

7. The lift mechanism of claim 1 further comprising: a distance between the extended position and the contracted position being about 84 inches.

8. The lift mechanism of claim 1 further comprising: a hand rail coupled to the lift deck.

9. A vehicle comprising:
a frame;
a support surface on the frame;
a deployment mechanism coupled to the frame and being operable for moving between a stowed position within the frame and a deployed position positioned to one side of the frame;
a lift mechanism coupled to the deployment mechanism, the lift mechanism being positioned to one side of the frame when the deployment mechanism moves from the stowed position to the deployed position, the lift mechanism being movable vertically between an extended position and a contracted position relative to the frame; and
a lift deck coupled to the lift mechanism whereby when the lift mechanism is in the extended position, the lift deck is positioned above the support surface.

10. The vehicle of claim 9 further comprising: a pneumatic system in fluid communication with the lift mechanism to move the lift mechanism between the extended position and the contracted position.

11. The vehicle of claim 9 further comprising: a housing, the lift mechanism to be housed in the housing when the lift mechanism is in the contracted position and the deployment mechanism is in the stowed position.

12. The vehicle of claim 9 further comprising: the vehicle being a flatbed vehicle and including a housing to contain the lift mechanism, the support surface being a flatbed, the frame being under the support surface, the housing being under the support surface.

13. The vehicle of claim 9 further comprising: the deployment mechanism deploying the lift mechanism from a driver's side of the vehicle.

14. A method of operating a vehicle comprising:
moving a lift mechanism that is coupled to a vehicle between a stowed position substantially beneath the vehicle and a deployed position that is substantially to one side of the vehicle;
moving the lift mechanism vertically between a contracted position and an extended position to lift a lift deck to a position above a support surface of the vehicle.

15. The method of claim 14 further comprising: placing a tarp on the lift deck, lifting the tarp with the lift deck, and spreading the tarp from the lift deck over a cargo on the vehicle

16. The method of claim 14 further comprising: using air from a pneumatic system of the vehicle to move the lift mechanism between the contracted position and the extended position.

17. The method of claim 14 further comprising: housing the lift mechanism on the vehicle.

18. The method of claim 14 wherein the deployed position is at a driver's left side of the vehicle.
